(19) United States
(12) Patent Application Publication
(10) Pub. No.: US 2026/0049876 A1
(43) Pub. Date: Feb. 19, 2026

(54) SENSOR CIRCUIT AND METHOD FOR COMPENSATING MECHANICAL STRESS OF A MAGNETO-RESISTIVE SENSOR

(71) Applicant: Infineon Technologies AG, Neubiberg (DE)

(72) Inventors: Johannes GÜTTINGER, Lind ob Velden (AT); Massimiliano ZILLI, Udine (IT); Udo HAFNER, Klagenfurt (AT)

(21) Appl. No.: 19/297,307

(22) Filed: Aug. 12, 2025

(30) Foreign Application Priority Data
Aug. 13, 2024 (DE) 102024123104.1

(51) Int. Cl. G01L 1/12; G01K 7/36

(52) U.S. Cl. CPC G01L 1/125; G01K 7/36

(57) ABSTRACT

A sensor circuit includes a first bridge circuit, which includes a plurality of first magneto-resistors having a first reference magnetization along a first directional axis, and an output for a first output signal in response to an external magnetic field. The sensor circuit also includes a second bridge circuit which includes a plurality of second magneto-resistors having a second reference magnetization along a second directional axis, and an output for a second output signal in response to the external magnetic field. The sensor circuit also includes a sensor configured to measure a physical quantity indicative of a reference magnetization rotation of the first and second magneto-resistors. The sensor circuit also includes processing circuitry configured to determine a compensated output signal based on the first output signal, the second output signal, and the physical quantity indicative of the reference magnetization rotation.

### CROSS-REFERENCE TO RELATED APPLICATION

This application claims priority to Germany Patent Application No. 102024123104.1 filed on Aug. 13, 2024, the content of which is incorporated by reference herein in its entirety.

### FIELD

The present disclosure generally relates to magnetoresistive sensor circuits, and, more particularly, to a concept for canceling or reducing one or more stress effects in magnetoresistive sensor circuits.

### BACKGROUND

Stress dependency of xMR sensors can manifest itself as changes of sensitivity and rotation of the reference system. The “x” in xMR stands for the specific type of magnetoresistance effect being utilized. Common types of xMR sensors are AMR (Anisotropic Magnetoresistance) sensors, GMR (Giant Magnetoresistance) sensors, TMR (Tunneling Magnetoresistance) sensors, or CMR (Colossal Magnetoresistance) sensors.

AMR sensors utilize the anisotropic magnetoresistance effect, where the electrical resistance changes based on the angle between the direction of current flow and the magnetization within the material. GMR sensors are based on the giant magnetoresistance effect, which involves large changes in electrical resistance due to the alignment of magnetization in alternating ferromagnetic and non-magnetic layers. TMR sensors utilize the tunneling magnetoresistance effect, where the resistance changes due to electron tunneling between ferromagnetic layers separated by an insulating barrier. The tunneling probability depends on the relative alignment of magnetizations in the ferromagnetic layers. CMR sensors rely on the colossal magnetoresistance effect, observed in some manganese oxide compounds, where resistance changes dramatically in response to an applied magnetic field.

In the context of xMR sensors, sensitivity refers to the sensor's ability to detect changes in the magnetic field. It is a measure of how much the sensor's output changes in response to a given change in the magnetic field. Mechanical stress can alter the material properties and the magnetic characteristics of the layers within the xMR sensor. This can cause the sensitivity to vary, meaning the sensor might become more or less responsive to changes in the magnetic field. For example, stress can cause changes in the resistance of the sensor, affecting the output signal for a given magnetic input.

In xMR sensors, the reference system usually refers to a fixed magnetic layer that provides a stable reference direction for measuring the relative angle of the free magnetic layer, which is free to rotate in response to external magnetic fields. Mechanical stress can physically distort the sensor, leading to a misalignment of the magnetic layers. This distortion can cause the reference magnetic layer to rotate or shift from its intended orientation. Such a rotation affects the accuracy of the sensor's measurements, as the reference direction is no longer stable and reliable. This can introduce errors in the measurement of the external magnetic field's direction and magnitude.

This stress dependency may cause problems with stray field suppression in speed and current sensors and orthogonality errors in angle sensors. This refers to the sensor's ability to ignore or filter out unwanted magnetic fields (stray fields) that do not come from a target signal source. Effective stray field suppression is needed for accurate measurements in magnetic sensing applications. As an example, despite of having a differential concept for stray field suppression, 25% of the stray field in orthogonal direction may enter the signal path in the worst case. In sensitive direction the sensitivity mismatch at different positions on a die of up to 10-15% may result also in a bad stray field rejection and inability of speed sensors to work with wheels where the signal pitch is much larger than the sensor pitch.

Thus, there may be a demand for canceling or reducing one or more xMR stress effects.

### SUMMARY

This demand is addressed by apparatuses and methods in accordance with the appended claims.

According to a first aspect, the present disclosure provides a sensor circuit. The sensor circuit includes a first bridge circuit. The first bridge circuit (half-bridge or full-bridge) includes a plurality of first magneto-resistors having a first reference magnetization along a first directional axis. The first bridge circuit includes an output for a first output signal in response to an external magnetic field. The sensor circuit includes a second bridge circuit. The second bridge circuit (half-bridge or full-bridge) includes a plurality of second magneto-resistors having a second reference magnetization along a second directional axis. The second bridge circuit includes an output for a second output signal in response to the (same) external magnetic field. The sensor circuit includes a sensor configured to measure a physical quantity indicative of a reference magnetization rotation of the first and second magneto-resistors. This reference magnetization rotation may be due to mechanical stress or other environmental factors. The sensor circuit further includes processing circuitry configured to determine a compensated output signal based on the first output signal, the second output signal, and the measured physical quantity indicative of the reference magnetization rotation. This compensation aims to correct the effects of the reference magnetization rotation.

An advantage of this sensor circuit design may be improved accuracy and reliability. By measuring the physical quantity indicative of the reference magnetization rotation and using it to compensate the output signals from the bridge circuits, the sensor can correct for errors caused by mechanical stress or other factors that would otherwise lead to inaccurate readings. This compensation may ensure that the sensor provides more precise and stable measurements, even in varying environmental conditions, enhancing its performance in applications requiring high accuracy, such as automotive sensors, industrial equipment, and consumer electronics.

In some implementations, the first reference magnetization and the second reference magnetization are orthogonal in absence of external perturbations (e.g., mechanical stress) acting on the sensor circuit. The first reference magnetization refers to the direction of magnetization in the first set of magneto-resistors in the absence of any external perturbations. The second reference magnetization refers to the direction of magnetization in the second set of magneto-resistors in the absence of any external perturbations. In an ideal, undisturbed state, the first and second reference magnetizations may be at right angles (90 degrees) to each other. Factors like mechanical stress or other environmental influences can alter/rotate the reference magnetizations. The reference magnetizations may be orthogonal when these perturbations are not present. An advantage of having orthogonal reference magnetizations in the absence of external perturbations may be improved sensitivity and accuracy in detecting magnetic fields. Orthogonal magnetizations may allow the sensor to more effectively detect and differentiate between changes in the magnetic field along different axes. This orthogonal arrangement may maximize the sensor's responsiveness to magnetic field variations. When external perturbations like mechanical stress are present, they can cause the reference magnetizations to rotate. Knowing that the initial state is orthogonal may allow the processing circuitry to more accurately calculate and apply the necessary compensations, correcting for any deviations caused by stress and ensuring the sensor outputs remain accurate. Orthogonal magnetizations may help in reducing cross-sensitivity between the two axes, meaning changes in the magnetic field along one axis have minimal influence on the sensor reading of the other axis.

In some implementations, the first bridge circuit includes a first Wheatstone bridge of four first magneto-resistors, and the second bridge circuit includes a second Wheatstone bridge of four second magneto-resistors. A Wheatstone bridge typically includes four resistors arranged in a diamond shape. It may have two input terminals for a voltage supply and two output terminals where the differential voltage is measured. In this case, the resistors are magneto-resistors, whose resistance changes in response to external magnetic fields. The differential voltage output from the bridge is a measure of the magnetic field. An advantage of using Wheatstone bridge configurations for the first and second bridge circuits may be high sensitivity and accuracy in detecting small changes in magnetic fields. Wheatstone bridges are sensitive to small changes in resistance. When magneto-resistors experience changes in external magnetic fields, the corresponding resistance changes may be detected with high precision. The Wheatstone bridge provides a balanced method to measure resistance changes. It may cancel out noise and common-mode signals, which might otherwise affect the accuracy of the sensor. The bridge's differential output may help in measuring small changes in resistance, making it suitable for precise magnetic field measurements.

In some implementations, the first output signal is a difference in voltage between middle nodes of the first bridge circuit, and the second output signal is a difference in voltage between middle nodes of the second bridge circuit. For half bridge configurations, the middle node is typically where the two resistors connect to form a single node. The voltage difference may be measured between this middle node and a reference point (usually ground or another fixed potential). This provides a simpler but still effective measure of the resistance change due to the magnetic field. For full bridge configurations, the middle nodes are the points where the pairs of resistors connect. In a full bridge, there are typically two such nodes. The difference in voltage between these two middle nodes is taken as the output signal. This differential output provides a measure of the change in resistance due to the external magnetic field.

In some implementations, the sensor is configured to measure a mechanical stress acting on the sensor circuit as the physical quantity indicative of the (stress-based) reference magnetization rotation. The reference magnetization rotation manifests itself as a rotation of the reference magnetization direction which in turn leads to a cross sensitivity to the field orthogonal to the magnetization direction. The mechanical stress acting on the sensor circuit can cause changes in the reference magnetization direction of the magneto-resistors. By measuring this stress, the sensor circuit can determine the extent of magnetization rotation and apply appropriate compensation to maintain accuracy. The physical quantity measured may be the mechanical stress, which is indicative of how much the reference magnetization has been rotated due to external factors such as pressure, temperature changes, or vibration. There are several ways to measure mechanical stress in a sensor circuit, including strain gauges, piezoresistive sensors, the piezoresistive effect in semiconductor materials, or capacitive sensors. By measuring mechanical stress and understanding its impact on the reference magnetization, the sensor circuit can apply compensations to correct for these effects. This may ensure that the output signals remain accurate despite the presence of stress.

In some implementations, the sensor is configured to measure a temperature acting on the sensor circuit as the physical quantity indicative of the reference magnetization rotation. By measuring the temperature, the sensor can infer the extent of magnetization rotation due to thermal effects and apply compensation to maintain accuracy. Temperature variations can cause thermal expansion or contraction of materials, leading to mechanical stress and subsequent changes in the reference magnetization direction of magneto-resistors. Measuring the temperature may help in determining how much the magnetization has rotated due to thermal effects. There are several methods to measure temperature in a sensor circuit, including thermocouples, thermistors, RTDs (Resistance Temperature Detectors), or semiconductor temperature sensors.

In some implementations, the processing circuitry is configured to scale the measured physical quantity by a predetermined scaling factor. This means that the sensor circuit may include processing circuitry that adjusts the measured physical quantity (such as stress or temperature) by multiplying it with a specific scaling factor. This scaling factor, also known as cross sensitivity coefficient, may be used to calibrate the impact of the physical quantity on the sensor's reference magnetization rotation. The processing circuitry may take the measured physical quantity (e.g., mechanical stress or temperature) and multiply it by a predetermined scaling factor. This may be the scaling factor used to quantify the relationship between the physical quantity and its effect on the reference magnetization rotation. It essentially calibrates the sensor to account for the degree of influence that the measured physical quantity has on the sensor's performance. The scaling may ensure that the compensation applied to the sensor output is proportional to the actual effect of the measured physical quantity. This may help in accurately correcting for deviations caused by stress or temperature change. By using a predetermined scaling factor, the sensor's compensation mechanism can be finely tuned to the specific characteristics of the physical quantity's impact on the reference magnetization.

In some implementations, the processing circuitry is configured to determine the compensated output signal based on a difference between the first output signal and the second output signal scaled based on the measured physical quantity. The first output signal is generated by the first bridge circuit in response to the external magnetic field. The second output signal is generated by the second bridge circuit in response to the same external magnetic field. The measured physical quantity could be a measurement of mechanical stress, temperature, or another factor affecting the sensor's reference magnetization and its output signals. The second output signal may be scaled by the measured physical quantity. This means that the second output signal may be adjusted by a predetermined scaling factor (cross sensitivity coefficient) based on the measured stress or temperature. The processing circuitry calculates the difference between the first output signal and the scaled second output signal. This difference, which now incorporates the influence of the measured physical quantity on the second output signal, results in a compensated output signal (e.g., the magnetic field component along the x-axis Bₓ) that accounts for external influences. This approach may improve the accuracy and reliability of the sensor by providing precise compensation for environmental influences, leading to consistent and robust performance.

In some implementations, the processing circuitry is configured to determine a first compensated output signal based on a difference between the first output signal and the second output signal scaled based on the measured physical quantity, and determine a second compensated output signal based on a sum of the second output signal and the first output signal scaled based on the measured physical quantity. The first compensated output signal (e.g., the magnetic field component along the x-axis Bₓ) may be determined by taking the difference between the first output signal and the second output signal, with the second output signal being scaled based on the measured physical quantity. The second compensated output signal (e.g., the magnetic field component along the y-axis B_{y}) may be determined by taking the sum of the second output signal and the first output signal, with the first output signal being scaled based on the measured physical quantity. This approach may allow for independent compensation of the magnetic field components along different axes, leading to more accurate and reliable multi-axis magnetic field measurements.

In some implementations, the processing circuitry is configured to determine a first compensated output signal based on a difference between the first output signal scaled with a first scaling factor based on a squared cross sensitivity and the second output signal scaled with a second scaling factor based on the cross sensitivity, and determine a second compensated output signal based on a sum of the second output signal scaled with the first scaling factor and the first output signal scaled with the second scaling factor. This may describe a method for computing compensated output signals Bx and By that accounts for cross sensitivity effects in xMR sensors. The first output signal may represent the magnetic field measurement along one axis (e.g., horizontal or Bₕₒᵣ). The second output signal may represent the magnetic field measurement along the orthogonal axis (e.g., vertical or Bᵥₑᵣₜ). Cross sensitivity (S_{cr}) may refer to the undesired influence of one axis's magnetic field on the measurement of the other axis due to mechanical stress or other factors. For determining the first compensated output signal (Bx), the first output signal (e.g., Bₕₒᵣ) may be scaled with a factor based on the squared cross sensitivity, e.g., (1−S_{cr}²/2). The second output signal (e.g., Bᵥₑᵣₜ) may be scaled with a factor based on the cross sensitivity S_{cr}. The first compensated output signal Bₓ may then be determined by taking the difference between these two scaled signals. For determining the second compensated output signal (By), the second output signal (e.g., Bᵥₑᵣₜ) may be scaled with a factor based on the squared cross sensitivity, e.g., (1−S_{cr}²/2). The first output signal (e.g., Bₕₒᵣ) may be scaled with a factor based on the cross sensitivity S_{cr}. The first compensated output signal Bₓ may then be determined by taking the sum between these two scaled signals. This may lead to a precise compensation for cross sensitivity effects, leading to enhanced measurement accuracy and reliability.

In some implementations, the sensor circuit further includes a third bridge circuit. The third bridge circuit includes a plurality of third magneto-resistors having the first reference magnetization along the first directional axis. The third bridge circuit includes an output for a third output signal in response to the external magnetic field. The first and the third bridge circuit from a differential sensor. The processing circuitry is configured to determine the compensated output signal based on the first to third output signals and the physical quantity indicative of the reference magnetization rotation. This describes an advanced sensor configuration for improved measurement accuracy and compensation. The first and third bridge circuits may be used together to form a differential sensor. A differential sensor uses two measurements (from the first and third bridge circuits) to enhance the accuracy and robustness of the output signal by canceling out common-mode noise and errors. By using a differential sensor configuration (first and third bridge circuits), the sensor may cancel out common-mode noise and environmental disturbances that equally affect both circuits. This may lead to more accurate and reliable measurements. The processing circuitry combines the output signals from all three bridge circuits (first, second, and third) and uses the measured physical quantity (indicative of reference magnetization rotation, such as mechanical stress or temperature) to determine a compensated output signal. The compensated output signal is calculated using the first, second, and third output signals, adjusted based on the measured physical quantity that indicates the extent of reference magnetization rotation. This configuration may improve measurement accuracy and noise reduction, ensuring reliable and precise sensor performance in various environmental conditions.

In some implementations, the processing circuitry is configured to determine the compensated output signal based on a difference between the first and third output signals, and second output signal which is scaled based on the measured physical quantity. This means that the sensor circuit includes three bridge circuits. The first bridge circuit contains magneto-resistors with a reference magnetization along the first directional axis and outputs the first signal in response to the external magnetic field. The second bridge circuit contains magneto-resistors with a reference magnetization along a second (typically orthogonal) directional axis and outputs the second signal in response to the external magnetic field. The third bridge circuit contains magneto-resistors with a reference magnetization along the first directional axis, similar to the first bridge circuit, and outputs the third signal in response to the external magnetic field. The processing circuitry calculates the difference between the first and third output signals. This difference helps to reduce common-mode noise and errors, enhancing the accuracy of the measurement. The second output signal is scaled based on the measured physical quantity (such as stress or temperature) to compensate for the influence of this physical quantity on the sensor's reference magnetization. The compensated output signal may be derived by combining the differential signal (difference between the first and third output signals) and the scaled second output signal. This method may ensure that the compensation takes into account the measured physical quantity, providing a more accurate and reliable sensor output. An advantage of this approach is enhanced compensation for environmental influences and improved accuracy. By using the difference between the first and third output signals, the sensor can effectively cancel out common-mode noise and environmental disturbances that affect both circuits equally. This may lead to more accurate and stable measurements. Scaling the second output signal based on the measured physical quantity may allow for precise compensation of errors due to mechanical stress, temperature variations, or other environmental factors, ensuring that the sensor output remains accurate under various conditions.

In some implementations, the magneto-resistors are tunnel magneto-resistors. TMR resistors leverage the tunneling magnetoresistance effect, which occurs when electrons tunnel through an insulating barrier between two ferromagnetic layers, with the resistance changing depending on the relative alignment of the magnetization in these layers. TMR resistors consist of two ferromagnetic layers separated by a thin insulating barrier. When a voltage is applied, electrons tunnel through the insulating barrier, and the resistance of the device changes depending on whether the magnetizations of the ferromagnetic layers are parallel or antiparallel. The resistance is lower when the magnetizations are parallel and higher when they are antiparallel. An advantage of using TMR resistors is high sensitivity and a large magnetoresistance ratio. TMR resistors typically have a much larger magnetoresistance ratio compared to other types of magneto-resistors, such as anisotropic magnetoresistors (AMR) or giant magnetoresistors (GMR). This means they can detect smaller changes in magnetic fields with greater precision. The high sensitivity of TMR resistors allows for more accurate detection of magnetic fields, which is crucial in applications requiring precise measurements, such as in hard disk drives, magnetic field sensors, and various types of sensing applications in automotive and industrial sectors.

In some implementations, the sensor circuit is an integrated circuit. This means that the sensor circuit, which includes the magneto-resistors and processing circuitry, may be fabricated as a single integrated circuit (IC) rather than being composed of separate, discrete components. An integrated circuit is a set of electronic components such as resistors, capacitors, transistors, and other devices, all manufactured onto a single piece of semiconductor material, typically silicon. This allows for the creation of compact, efficient, and high-performance electronic systems.

According to a further aspect, the present disclosure provides a method for compensating mechanical stress of a magneto-resistive sensor. The method includes receiving, in response to an external magnetic field, a first output signal from one or more first magneto-resistors having a first reference magnetization along a first directional axis (e.g., x-axis). The method includes receiving, in response to the external magnetic field, a second output signal from one or more second magneto-resistors having a second reference magnetization in along a second directional axis (e.g., y-axis). The method includes receiving an additional sensor signal indicative of a reference magnetization rotation of the first and second magneto-resistors. The method further includes determining a compensated output signal based on the first output signal, the second output signal, and the additional sensor signal.

In some implementations, the method includes determining the compensated output signal based on a difference between the first output signal and the second output signal which is scaled based on the additional sensor signal.

In some implementations, the method includes determining a first compensated output signal based on a difference between the first output signal and the second output signal which is scaled based on the additional sensor signal, and determining a second compensated output signal based on a sum of the second output signal and the first output signal which is scaled based on the additional sensor signal.

In some implementations, the method includes determining a first compensated output signal based on a difference between the first output signal scaled with a first scaling factor based on the squared cross sensitivity and the second output signal scaled with a second scaling factor based on the cross sensitivity, and determining a second compensated output signal based on a sum of the second output signal scaled with the first scaling factor and the first output signal scaled with the second scaling factor.

According to a further aspect, the present disclosure provides a computer program including a sequence of instructions, wherein the instructions, when executed by a processor, cause the processor to execute the method of any one of the previous examples.

The present disclosure proposes a scheme to cancel both xMR stress effects locally by compensating the sensitivity loss and reference angle rotation with a linear compensation that can be implemented in analog or digital circuitry. The sheer stress can be measured directly with a rotated current mirror or indirectly over the strong temperature dependence.

### BRIEF DESCRIPTION OF THE DRAWINGS

Some examples of apparatuses and/or methods will be described in the following by way of example only, and with reference to the accompanying figures, in which

FIG. 1 shows a schematic representation of a layer stack of a magnetoresistive sensor element;

FIG. 2 illustrates a relationship between cross sensitivity and reference system rotation in a magnetic sensor system;

FIG. 3A shows a sensor circuit according to an implementation of the present disclosure;

FIG. 3B shows a sensor circuit according to a further implementation of the present disclosure;

FIG. 4 shows a differential sensor circuit according to an implementation of the present disclosure;

FIG. 5A shows a differential sensor circuit according to a further implementation of the present disclosure;

FIG. 5B shows a differential sensor circuit according to a further implementation of the present disclosure;

FIG. 5C shows alternative setup for the second bridge circuit;

FIG. 6 shows an angle sensor circuit with first order compensation according to an implementation of the present disclosure; and

FIG. 7 shows an angle sensor circuit with second order compensation according to an implementation of the present disclosure.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

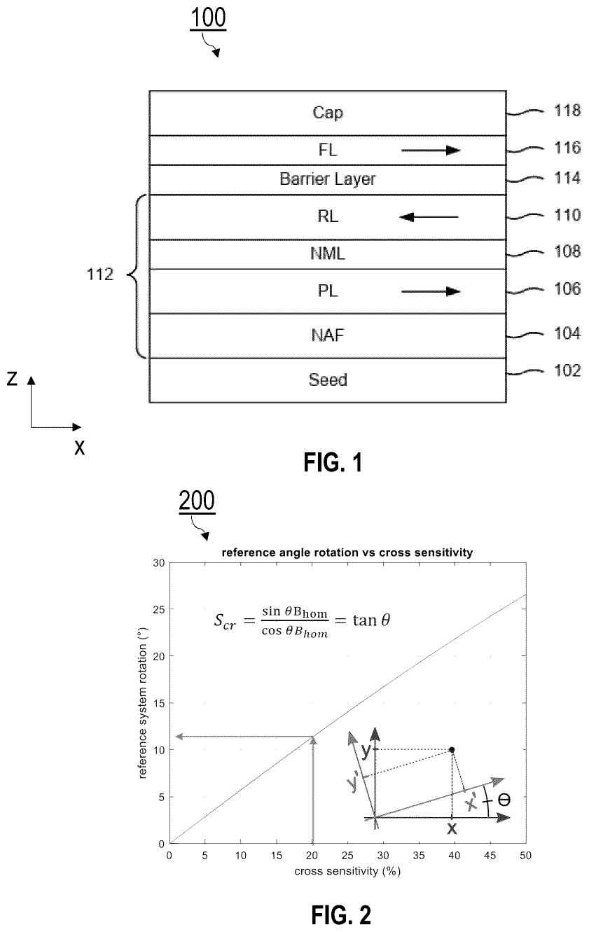

FIG. 1 shows an example of a layer stack of a magnetoresistive sensor element 100 according to one or more implementations.

The magnetoresistive sensor element 100 can, for example, be a TMR sensor element with a bottom-pinned spin-valve (BSV) configuration. GMR sensor elements are also possible. The magnetoresistive sensor element 100 can be arranged on a semiconductor substrate (not shown) of a magnetoresistive sensor. In the description using a Cartesian coordinate system with mutually perpendicular coordinate axes x, y, and z, the layers of the layer stack extend laterally in an xy-plane spanned by the x- and y-axes. Thus, lateral dimensions (e.g., lateral distances, lateral cross-sectional areas, lateral surfaces, lateral extensions, lateral displacements, etc.) can refer to dimensions in the xy-plane, and vertical dimensions can refer to dimensions in the z-direction, perpendicular to the xy-plane. For example, the vertical extension of a layer in the z-direction can be referred to as the layer thickness.

The layer stack of the magnetoresistive sensor element 100 comprises at least one reference layer with a reference magnetization (e.g., a reference direction in the case of GMR or TMR technology). The reference magnetization is a magnetization direction that provides a sensor direction corresponding to a sensor axis of the magnetoresistive sensor element 100. The reference layer and thus the reference magnetization define a sensor plane. The sensor plane can, for example, be defined by the xy-plane. Thus, the x-direction and the y-direction can be referred to as “in-plane” concerning the sensor plane, and the z-direction can be referred to as “out-of-plane” concerning the sensor plane.

Accordingly, in the case of a GMR sensor element or a TMR sensor element, the resistance of the magnetoresistive sensor element 100 is minimal when the free magnetization of a magnetic free layer points exactly in the same direction as the reference magnetization (e.g., the reference direction), and the resistance of the magnetoresistive sensor element 100 is maximal when the free magnetization of the magnetic free layer points exactly in the opposite direction to the reference magnetization. The alignment of the free magnetization of the magnetic free layer is variable in the presence of an external magnetic field. Thus, the resistance of the magnetoresistive sensor element 100 can vary based on the influence of the external magnetic field on the free magnetization of the free layer.

From bottom to top, the magnetoresistive sensor element 100 can include an optional seed layer 102, which can be used to influence and/or optimize stack growth. In some implementations, the seed layer 102 can consist of copper (Cu), tantalum (Ta), ruthenium (Ru), or a combination thereof. In the example shown, a natural antiferromagnetic (NAF) layer 104 is formed or otherwise arranged on the seed layer 102. The NAF layer 104 can consist of platinum-manganese (PtMn), iridium-manganese (IrMn), nickel-manganese (NiMn), or the like. The thickness of the NAF can, for example, range from 5 nm to 50 nm.

Furthermore, a pinned layer (PL) 106 can be formed or otherwise arranged on the NAF layer 104. The pinned layer 106 can consist of a ferromagnetic material such as cobalt-iron (CoFe) or cobalt-iron-boron (CoFeB). A contact between the NAF layer 104 and the pinned layer 106 can induce an effect known as the exchange bias effect, causing the magnetization of the pinned layer 106 to align in a preferred direction (e.g., in the x-direction, as shown). The magnetization of the pinned layer 106 can be referred to as pinned magnetization. The pinned layer 106 can exhibit a linear magnetization pattern in the xy-plane (e.g., a homogeneous alignment in one direction) that is permanently fixed.

The magnetoresistive sensor element 100 also includes a non-magnetic layer (NML), referred to as a coupling interlayer 108. In one possible implementation, the coupling interlayer 108 can include ruthenium (Ru), iridium (Ir), copper (Cu), copper alloys, or similar materials. Other materials (e.g., paramagnets) are also possible. A magnetic (e.g., ferromagnetic) reference layer (RL) 110 can be formed or otherwise arranged on the coupling interlayer 108. The thickness of the pinned layer 106 and the magnetic reference layer 110 can range from 1 nm to 10 nm, for example.

Accordingly, the coupling interlayer 108 can be arranged between the pinned layer 106 and the magnetic reference layer 110 to spatially separate the pinned layer 106 and the magnetic reference layer 110 in the vertical direction. Furthermore, the coupling interlayer 108 can provide interlayer exchange coupling (e.g., an antiferromagnetic Ruderman-Kittel-Kasuya-Yosida (RKKY) coupling) between the pinned layer 106 and the magnetic reference layer 110 to form an artificial antiferromagnet. Consequently, the magnetization of the magnetic reference layer 110 can align and be maintained in a direction that is antiparallel or opposite to the magnetization of the pinned layer 106 (e.g., in the x-direction, as shown). The magnetization of the magnetic reference layer 110 can be referred to as reference magnetization.

Since the NAF layer 104 is configured to align and fix the magnetization of the pinned layer 106 in a certain direction, and the coupling interlayer 108 is configured to align and fix the magnetization of the magnetic reference layer 110 in an opposite direction, it can be the that the NAF layer 104 is configured to maintain the magnetization of the pinned layer 106 (e.g., a fixed magnetization) in a first magnetic orientation and to maintain the magnetization of the magnetic reference layer 110 (e.g., a fixed reference magnetization) in a second magnetic orientation. The magnetic reference layer 110 can exhibit a linear magnetization pattern in a specific direction in the xy-plane when the pinned layer 106 exhibits a linear magnetization pattern in an antiparallel direction. Thus, the NAF layer 104, the pinned layer 106, the coupling interlayer 108, and the magnetic reference layer 110 form a magnetic reference layer system 112 of the magnetoresistive sensor element 100.

The magnetoresistive sensor element 100 additionally includes a barrier layer 114 (e.g., a tunnel barrier) vertically arranged between the reference layer system 112 and a free magnetic layer 116. The barrier layer 114 can, for example, be formed or otherwise arranged on the magnetic reference layer 110 of the reference layer system 112, and the free magnetic layer 116 can be formed or otherwise arranged on the barrier layer 114.

The barrier layer 114 can consist of a non-magnetic material. In some implementations, the barrier layer 114 can be an electrically insulating tunnel barrier layer. For example, the barrier layer 114 can be a tunnel barrier layer used to generate a TMR effect. The barrier layer 114 can consist of magnesium oxide (MgO) or another material with similar properties.

The material of the free magnetic layer 116 can be an alloy of a ferromagnetic material, such as CoFe, CoFeB, or NiFe. The free magnetic layer 116 has a free magnetization that is variable in the presence of an external magnetic field. Therefore, the free magnetic layer 116 can be referred to as a sensor layer, as changes in the free magnetization can be used to determine a measured variable. Furthermore, the free magnetization has a magnetic standard orientation in a ground state (such as vortex magnetization). The ground state is a state in which the influence of the external magnetic field on the free magnetic layer 116 is absent or negligibly small. In some implementations, the magnetoresistive sensor element 100 can include a free magnetic system comprising a plurality of layers (e.g., two or more free magnetic layers) that together act as the free magnetic layer. In this case, the free magnetic layers of the free magnetic system are magnetically coupled to each other. Thus, the free magnetic system can function as a free magnetic layer but also consist of several layers. The free magnetic system has a free magnetization, where the free magnetization is variable in the presence of the external magnetic field.

A capping layer 118, such as tantalum (Ta), tantalum nitride (TaN), ruthenium (Ru), titanium (Ti), titanium nitride (TiN), platinum (Pt), or the like, can be formed or otherwise arranged on the free magnetic layer 116 to form an upper layer of the magnetoresistive sensor element 100.

The seed layer 102 can serve as a bottom electrode or establish an electrical contact with a bottom electrode (not shown) of the magnetoresistive sensor element 100. The capping layer 118 can establish an electrical contact with a top electrode (not shown) of the magnetoresistive sensor element 100. The barrier layer 114 can be configured so that electrons can tunnel between the reference layer system 112 and the free magnetic layer 116 when a bias is applied to the electrodes of the magnetoresistive sensor element 100 (not shown) to generate a magnetoresistance effect (e.g., a TMR effect).

As mentioned above, FIG. 1 serves merely as an example of a magnetoresistive sensor element or magneto-resistor. Other examples can deviate from the description in FIG. 1. The number and arrangement of the components shown in FIG. 1A are an example. In practice, the magneto-resistor 100 can contain additional elements or layers.

Mechanical stress can rotate the reference magnetization of magnetic reference layer 110 or reference layer system 112 compared to its orientation in a stress-free state. Mechanical stress can affect the magnetic properties of materials due to magnetoelastic coupling, which is the interaction between magnetic and elastic properties of a material. When a magnetic material is subjected to mechanical stress, the stress can induce changes in the material's magnetic anisotropy, leading to a rotation of the reference magnetization direction. Magnetoelastic coupling is the interaction between the magnetic and mechanical properties of a material. Stress can alter the magnetic energy landscape of the material, causing changes in the direction of reference magnetization. Mechanical stress can create or modify anisotropy in the material. Anisotropy refers to the directional dependence of the material's magnetic properties. Stress can either enhance or reorient existing anisotropy, leading to a rotation of the reference magnetization. In TMR sensors or other magnetoresistive sensors, any rotation of the reference magnetization due to mechanical stress can lead to errors in the sensor's output, as the sensor relies on a stable and well-defined magnetization direction for accurate measurements.

FIG. 2 illustrates a relationship between cross sensitivity S_{cr} and reference system rotation θ in a magnetic sensor system. The x-axis in FIG. 2 represents cross sensitivity S_{cr} as a percentage (%). The y-axis in FIG. 2 represents reference system rotation θ in degrees (°).

$${S}_{cr} = \frac{sin θ {B}_{hom}}{cos θ {B}_{hom}} = tan θ \qquad Equation$$

shows that cross sensitivity S_{cr} is substantially equal to the tangent of the angle θ of reference system rotation or reference magnetization rotation. The diagonal line in graph 200 indicates a direct proportional relationship between cross sensitivity S_{cr} and reference magnetization rotation θ. As reference system/magnetization rotation θ increases, cross sensitivity S_{cr} also increases. For instance, a cross sensitivity of around 20% corresponds to a reference system/magnetization rotation of approximately 11°.

The inset diagram in the lower right corner of FIG. 2 visually represents the rotation of the reference system by the rotation angle θ. While the original axes (x and y) represent the original reference (coordinate) system, the axes (x′ and y′) represent the rotated reference system, e.g., due to mechanical stress.

A rotated reference system may cause misalignment between the actual magnetic field direction and the sensor's perceived direction. This misalignment may result in errors in the measurement of magnetic field components. The sensor may incorrectly interpret the magnitude and direction of the magnetic field, leading to inaccurate readings. As the reference system rotates, the sensor becomes more sensitive to magnetic fields in directions it was originally less sensitive to (increased cross sensitivity). This increased cross sensitivity can introduce noise and errors in the measurements, particularly in multi-axis sensors. Further, the rotation can cause interference between the orthogonal axes (e.g., x- and y-axes), making it difficult to isolate the magnetic field components accurately.

The present disclosure proposes compensation concepts that account for the rotated reference system and can help correct the measurement values. The proposed compensation concepts may use a known relationship between cross sensitivity and reference angle rotation (see, e.g., FIG. 2) to adjust the readings, for example.

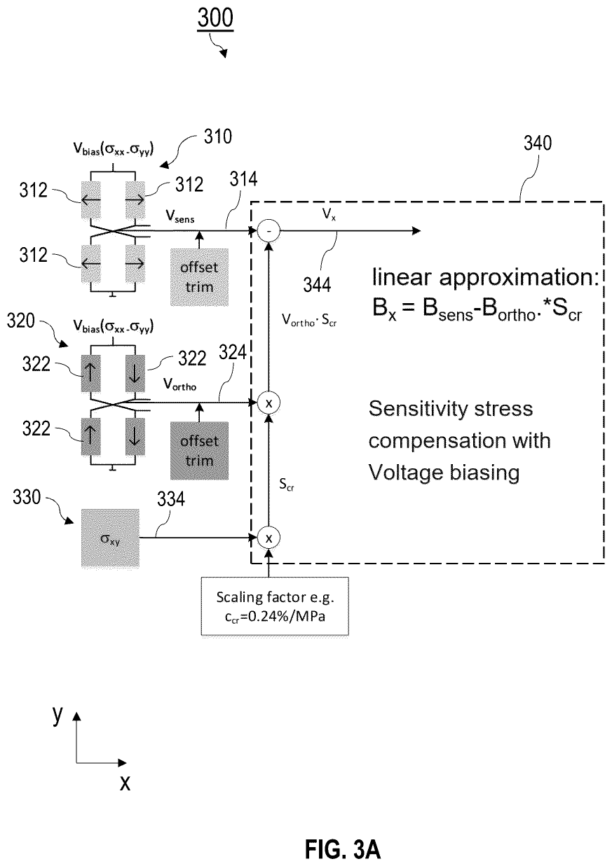

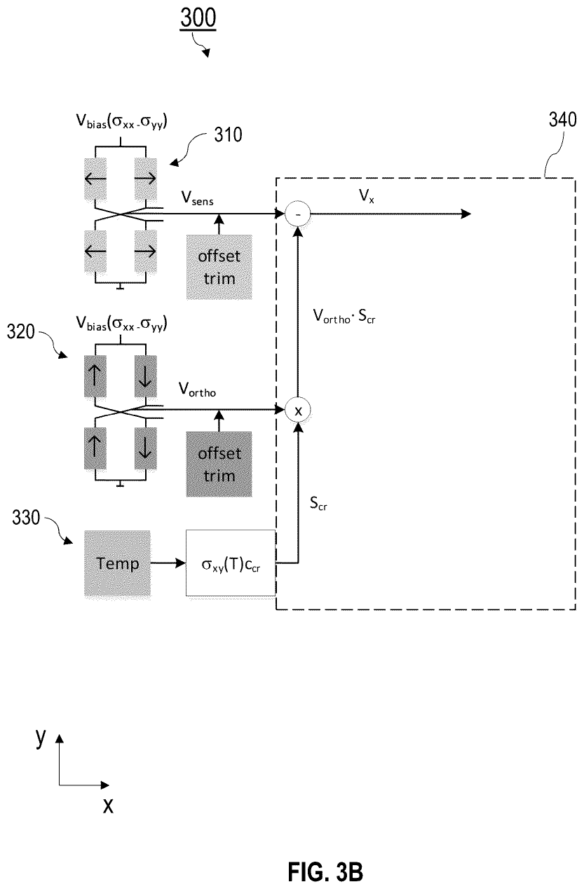

FIG. 3A shows a sensor circuit 300 according to an implementation of the present disclosure.

Sensor circuit 300 comprises a first bridge circuit 310. First bridge circuit 310 comprises a plurality of first magneto-resistors 312 having a first reference magnetization along a first directional axis (here: x-axis). First bridge circuit 310 also comprises an output 314 for a first output signal Vₛₑₙₛ in response to an external magnetic field. In the illustrated example, first bridge circuit 310 is implemented as a Wheatstone bridge having four first magneto-resistors 312. Ideally (e.g., without stress), the reference magnetization of the magneto-resistors 312 of the left leg points in negative x-direction. Ideally, the reference magnetization of the magneto-resistors 312 of the right leg points in positive x-direction (e.g., 180° shifted with respect to the left leg). First bridge circuit 310 may optionally comprise an offset trim component to correct any inherent offsets in the sensor output Vₛₑₙₛ, ensuring that the output Vₛₑₙₛ is accurately centered around zero when no external magnetic field is present. In the illustrated example, first bridge circuit 310 is configured to measure an x-component of an external magnetic field and produces an output voltage Vₛₑₙₛ. The output voltage Vₛₑₙₛ may be a difference in voltage between middle nodes of the left and right legs of the first bridge circuit 310. The skilled person having benefit from the present disclosure will appreciate that first bridge circuit 310 could as well be implemented as a half bridge.

First bridge circuit 310 comprises an upper left magneto-resistor 312, a lower left magneto-resistor 312, an upper right magneto-resistor 312, and a lower right magneto-resistor 312. The reference magnetization of upper left magneto-resistor 312 and lower left magneto-resistor 312 points in negative x-direction. The reference magnetization of upper right magneto-resistor 312 and lower right magneto-resistor 312 points in positive x-direction. Upper left magneto-resistor 312 and lower right magneto-resistor 312 are connected in series between supply potential and ground (first series connection). Upper right magneto-resistor 312 and lower left magneto-resistor 312 are connected in series between supply potential and ground (second series connection). The output voltage Vₛₑₙₛ may be a difference in voltage between middle nodes the first series connection and the second series connection of the first bridge circuit 310.

Sensor circuit 300 additionally comprises a second bridge circuit 320. Second bridge circuit 320 comprises a plurality of second magneto-resistors 322 having a second reference magnetization along a second directional axis (here: y-axis). Second bridge circuit 320 also comprises an output 324 for a second output signal Vₒᵣₜₕₒ in response to the external magnetic field. In the illustrated example, second bridge circuit 320 is implemented as a Wheatstone bridge having four first magneto-resistors 322. Ideally (e.g., without stress), the reference magnetization of the magneto-resistors 322 of the left leg points in positive y-direction. Ideally, the reference magnetization of the magneto-resistors 322 of the right leg points in negative y-direction (e.g., 180° shifted with respect to the left leg). Second bridge circuit 320 may optionally comprise an offset trim component to correct any inherent offsets in the sensor output Vₒᵣₜₕₒ, ensuring that the output Vₒᵣₜₕₒ is accurately centered around zero when no external magnetic field is present. In the illustrated example, second bridge circuit 320 is configured to measure a y-component of the external magnetic field and produces an output voltage Vₒᵣₜₕₒ. The output voltage Vₒᵣₜₕₒ may be a difference in voltage between middle nodes of the left and right legs of the second bridge circuit 320. The skilled person having benefit from the present disclosure will appreciate that second bridge circuit 320 could as well be implemented as a half bridge.

Second bridge circuit 320 comprises an upper left magneto-resistor 322, a lower left magneto-resistor 322, an upper right magneto-resistor 322, and a lower right magneto-resistor 322. The reference magnetization of upper left magneto-resistor 322 and lower left magneto-resistor 322 points in positive y-direction. The reference magnetization of upper right magneto-resistor 322 and lower right magneto-resistor 322 points in negative y-direction. Upper left magneto-resistor 322 and lower right magneto-resistor 322 are connected in series between supply potential and ground (first series connection). Upper right magneto-resistor 322 and lower left magneto-resistor 322 are connected in series between supply potential and ground (second series connection). The output voltage Vₒᵣₜₕₒ may be a difference in voltage between middle nodes the first series connection and the second series connection of the second bridge circuit 320.

Sensor circuit 300 further comprises a sensor 330 configured to measure a physical quantity 334 indicative of a reference system/magnetization rotation θ of the first magneto-resistors 312 and the second magneto-resistors 322. The physical quantity 334 measured by sensor 330 may be mechanical stress, temperature, or any other factor that influences the orientation of the reference magnetization in the magneto-resistors 312, 322. The measured physical quantity may help determine how much the reference system/magnetization has rotated due to external influences.

In some implementations, all components of sensor circuit 300 may be implemented on a common substrate, such as a common semiconductor substrate (die), for example. That is, sensor circuit 300 may be an integrated sensor circuit (sensor IC).

In one implementation (FIG. 3A), the sensor 330 may be configured to measure the mechanical (sheer) stress acting on the sensor circuit 300 as the physical quantity indicative of a reference magnetization change that manifests itself as a rotation θ of the reference magnetization direction which in turn leads to a cross sensitivity S_{cr} to the field orthogonal to the magnetization direction.

Mechanical stress can be measured using various techniques and specialized circuitry configured to detect and quantify stress. For example, the piezoresistive effect utilizes the change in resistance of a material under mechanical stress. A plain resistor stripe's resistance changes according to the stress applied, which can be measured and used to quantify the stress. With the piezo-MOS effect, mechanical stress alters the mobility of charge carriers in the channels of MOSFETs, affecting the current gain and threshold voltage. These changes can be measured to determine the stress. The piezo-junction effect involves changes in the mobility of minority carriers in the base of a bipolar transistor and alterations in the intrinsic carrier density, affecting the saturation current. The stress can be measured by observing these changes. With the piezo-Hall effect, the mechanical stress alters the Hall coefficient, which changes the current-related magnetic sensitivity of Hall plates. Measuring the changes in Hall sensitivity can indicate the level of stress.

For example, sensor 330 may comprise MOS-current mirrors with current flow directions in orthogonal directions, which may serve as stress-sensitive elements. An advantage is that the signal is in the current domain, making it simple to multiplex an array of elements onto a single terminal. A combination of low n-doped lateral resistors in L-layout (lateral resistors) and low n-doped vertical resistors (vertical resistors) may be used to measure stress. The difference in their resistance changes under stress may be used to quantify the stress. Four resistors in an L-layout may form a Wheatstone bridge circuit. The output voltage of the bridge is proportional to the difference in in-plane normal stress components (σₓₓ-σ_{yy}), allowing a measurement of stress.

In another implementation of sensor circuit 300 (FIG. 3B), the sensor 330 may be configured to measure a temperature acting on the sensor circuit 300 as the physical quantity indicative of the mechanical (sheer) stress and thus the reference magnetization rotation. By measuring temperature, sensor 330 can infer the extent of magnetization rotation due to thermal effects and apply compensation to maintain accuracy. Temperature variations can cause thermal expansion or contraction of materials, leading to mechanical stress and subsequent changes in the reference magnetization direction of magneto-resistors. Measuring the temperature may help in determining how much the magnetization has rotated due to thermal effects. There are several methods to measure temperature in a sensor circuit, including thermocouples, thermistors, RTDs (Resistance Temperature Detectors), or semiconductor temperature sensors. The stress measurement can thus be replaced also with a temperature measurement and a conversion like S_{cr} (T)=(T−150)/(190)*0.2 obtained from measurement data, for example. Remaining cross sensitivity is expected to be on the level of approx. +−3% and may be further reduced by sample fine trimming at 150°: S_{cr}(T)(T−150)/(190)*0.2+trim.

Temperature and/or stress sensors may be placed near the circuit elements 310, 320 to measure temperature and/or stress acting on circuit elements 310, 320 and providing inputs to compensation circuits that correct for stress-induced drifts.

Sensor circuit 300 further comprises processing circuitry (compensation circuit) 340 configured to determine a compensated output signal 344 based on the first output signal Vₛₑₙₛ, the second output signal Vₒᵣₜₕₒ, and the physical quantity 334 indicative of the reference system/magnetization rotation θ. The compensation can be done based on the following relationship:

$$[ \begin{matrix}{B}_{x} \\ {B}_{y}\end{matrix} ] = [ \begin{matrix}cos θ & - sin θ \\ sin θ & cos θ\end{matrix} ] [ \begin{matrix}{B}_{sens} \\ {B}_{ortho}\end{matrix} ] ,$$

wherein Bₛₑₙₛ corresponds to the first output signal, Bₒᵣₜₕₒ corresponds to the second output signal, Bₓ corresponds to a compensated first output signal, and B_{y} corresponds to a compensated second output signal.

That is, based on the first and second output signals Bₛₑₙₛ and Bₒᵣₜₕₒ, the compensated first output signal Bₓ may be determined according to

$${B}_{x} = {B}_{s e n s} cos θ - {B}_{ortho} sin θ ,$$

$${B}_{x} \approx {B}_{s e n s} - {B}_{ortho} θ = {B}_{s e n s} - {B}_{ortho} tan ( {S}_{c r} ) ,$$

$${B}_{x} \approx {B}_{s e n s} - {B}_{o r t h o} {S}_{cr} ,$$

$${B}_{x} \approx {B}_{s e n s} - {B}_{o r t h o} {σ}_{xy} {c}_{cr} .$$

This equation represents a linear approximation where Bₓ is the compensated magnetic field component in x-direction. It may be calculated by subtracting the product of the orthogonal voltage output Bₒᵣₜₕₒ and the cross sensitivity S_{cr} from the primary voltage output Bₛₑₙₛ.

Based on the first and second output signals Bₛₑₙₛ and Bₒᵣₜₕₒ, the compensated second output signal B_{y} may be determined according to

$${B}_{y} = {B}_{s e n s} sin θ + {B}_{ortho} cos θ ,$$

$${B}_{y} \approx {B}_{s e n s} θ + {B}_{ortho} = {B}_{s e n s} tan ( {S}_{c r} ) + {B}_{ortho} ,$$

$${B}_{y} \approx {B}_{s e n s} {S}_{c r} + {B}_{ortho} ,$$

$${B}_{y} \approx {B}_{s e n s} {σ}_{x y} {c}_{c r} + {B}_{ortho} .$$

This equation represents a linear approximation where B_{y} is the compensated magnetic field component in y-direction. It may be calculated by summing the voltage output Bₛₑₙₛ multiplied by the cross sensitivity S_{cr} and the orthogonal voltage output Bₒᵣₜₕₒ.

Here, θ=atan(S_{cr}) denotes the reference magnetization rotation, S_{cr}=σ_{xy}c_{cr} denotes the cross sensitivity, and c_{cr}=e.g., 0.3%/Mpa denotes the cross sensitivity coefficient. The sheer stress σ_{xy} can be measured or trimmed using a temperature dependent LUT value, for example. Thus, processing circuitry 340 may be configured to further scale the measured physical quantity indicative of (sheer) stress σ_{xy}, by a predetermined scaling factor c_{cr} (cross sensitivity coefficient). The cross sensitivity coefficient is dependent on material. The cross sensitivity coefficient refers to how sensitive a sensor or material is to unintended stimuli, such as mechanical stress, which can cause deviations in the sensor's intended measurements. Different materials may have varying stiffness, which affects how they deform under stress. Materials with a higher elastic modulus may generally show lower deformation, impacting the cross sensitivity. Materials like silicon exhibit piezoresistive effects, where mechanical stress changes electrical resistance. The magnitude of this effect varies with the material's properties. The atomic arrangement in the material may affect how stress propagates through it. Single-crystal silicon, for example, has anisotropic properties, meaning its response to stress varies with direction. In silicon, the level and type of doping (n-type or p-type) may impact the piezoresistive coefficients. Highly doped silicon may have different stress sensitivities compared to lightly doped silicon. The temperature dependence of piezoresistive effects means that the cross sensitivity can vary with temperature. This dependency is material-specific, requiring calibration for accurate compensation. Thus, the cross sensitivity coefficient is dependent on the material, influenced by its intrinsic properties, doping levels, temperature effects, and fabrication processes.

Processing circuitry 340 of FIG. 3A or 3B may be configured to determine the compensated output signal Bₓ based on a difference between the first output signal Bₛₑₙₛ and the second output signal Bₒᵣₜₕₒ which is scaled based on the measured physical quantity, for example, scaled by S_{cr}=π_{xy}c_{cr}. Additionally, or alternatively, processing circuitry 340 may be configured to determine the compensated output signal B_{y} based on a sum of the second output signal Bₒᵣₜₕₒ and the first output signal Bₛₑₙₛ which is scaled based on the measured physical quantity 334, for example, scaled by S_{cr}=σ_{xy}c_{cr}. The material-specific scaling factor c_{cr} (e.g., 0.24%/MPa) may be used to quantify the sensor's sensitivity to mechanical stress (σ_{xy}). 0.24%/MPa means that for every megapascal (MPa) of stress applied, the parameter in question (e.g., output voltage) changes by 0.24 percent.

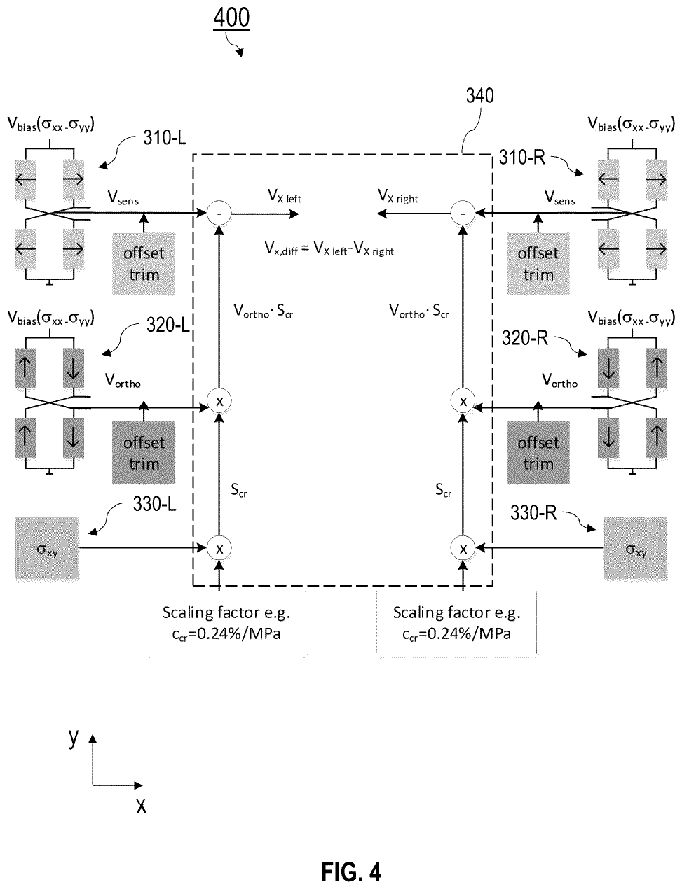

FIG. 4 shows a sensor circuit 400 according to another implementation of the present disclosure. Here, the external magnetic field component Bₓ may be determined differentially. A differential measurement of external magnetic field component Bₓ involves comparing the magnetic field detected by two or more sensors to measure the difference between their outputs. This technique may help to improve the accuracy and sensitivity of the measurement by reducing the influence of common-mode noise and other external disturbances. In differential measurement, two magnetic sensors are placed in close proximity but separated by a small distance. These sensors detect the magnetic field component Bₓ at their respective locations.

The outputs of the two sensors are compared to find the difference between them. This differential output effectively measures the change in the magnetic field over the distance between the sensors. Differential sensor circuit 400 comprises a first left bridge circuit 310-L. First left bridge circuit 310-L comprises a plurality of first magneto-resistors 312 having a first reference magnetization along a first directional axis (here: x-axis). First left bridge circuit 310-L also comprises an output for a first left output signal V_{sens,left} in response to an external magnetic field. In the illustrated example, first left bridge circuit 310-L is implemented as a Wheatstone bridge having four first magneto-resistors 312. Ideally (e.g., without stress), the reference magnetization of the magneto-resistors 312 of the left leg points in negative x-direction. Ideally, the reference magnetization of the magneto-resistors 312 of the right leg points in positive x-direction. First left bridge circuit 310-L may optionally comprise an offset trim component to correct any inherent offsets in the sensor output, ensuring that the output is accurately centered around zero when no external magnetic field is present. In the illustrated example, first left bridge circuit 310-L is configured to measure an x-component of an external magnetic field and produces an output voltage V_{sens,left}. The output voltage V_{sens,left} may be a difference in voltage between middle nodes of the left and right legs of the first left bridge circuit 310-L. The skilled person having benefit from the present disclosure will appreciate that first left bridge circuit 310-L could as well be implemented as a half bridge.

Differential sensor circuit 400 additionally comprises a second left bridge circuit 320-L. Second left bridge circuit 320-L comprises a plurality of second magneto-resistors 322 having a second reference magnetization along a second directional axis (here: y-axis). Second left bridge circuit 320-L also comprises an output for a second output signal V_{ortho,left} in response to the external magnetic field. In the illustrated example, second left bridge circuit 320-L is implemented as a Wheatstone bridge having four first magneto-resistors 322. Ideally (e.g., without stress), the reference magnetization of the magneto-resistors 322 of the left leg points in positive y-direction. Ideally, the reference magnetization of the magneto-resistors 322 of the right leg points in negative y-direction. Second left bridge circuit 320-L may optionally comprise an offset trim component to correct any inherent offsets in the sensor output, ensuring that the output is accurately centered around zero when no external magnetic field is present. In the illustrated example, second left bridge circuit 320-L is configured to measure a y-component of the external magnetic field and produces an output voltage V_{ortho,left}. The output voltage V_{ortho,left} may be a difference in voltage between middle nodes of the left and right legs of the second left bridge circuit 320-L. The skilled person having benefit from the present disclosure will appreciate that second bridge circuit 320 could as well be implemented as a half bridge.

Differential sensor circuit 400 further comprises a left sensor 330-L configured to measure a physical quantity 334 indicative of a reference magnetization rotation θ of the first left magneto-resistors 312 and the second left magneto-resistors 322. The physical quantity 334 measured by sensor 330 may be mechanical stress, temperature, or any other factor that influences the orientation of the reference magnetization in the magneto-resistors 312, 322.

Differential sensor circuit 400 further comprises a first right bridge circuit 310-R placed in close proximity but separated by a small distance from first left bridge circuit 310-L. First right bridge circuit 310-R comprises a plurality of first magneto-resistors 312 having a first reference magnetization along a first directional axis (here: x-axis). First right bridge circuit 310-R also comprises an output for a first right output signal V_{sens,right} in response to the external magnetic field. In the illustrated example, first right bridge circuit 310-R is implemented as a Wheatstone bridge having four first magneto-resistors 312. Ideally (e.g., without stress), the reference magnetization of the magneto-resistors 312 of the left leg points in negative x-direction. Ideally, the reference magnetization of the magneto-resistors 312 of the right leg points in positive x-direction. First right bridge circuit 310-R may optionally comprise an offset trim component to correct any inherent offsets in the sensor output, ensuring that the output is accurately centered around zero when no external magnetic field is present. In the illustrated example, first right bridge circuit 310-R is configured to measure an x-component of an external magnetic field and produces an output voltage V_{sens,right}. The output voltage V_{sens,right} may be a difference in voltage between middle nodes of the left and right legs of the first right bridge circuit 310-R. The skilled person having benefit from the present disclosure will appreciate that first right bridge circuit 310-R could as well be implemented as a half bridge.

Differential sensor circuit 400 additionally comprises a second right bridge circuit 320-R placed in close proximity but separated by a small distance from second left bridge circuit 320-L. Second right bridge circuit 320-R comprises a plurality of second magneto-resistors 322 having a second reference magnetization along a second directional axis (here: y-axis). Second right bridge circuit 320-R also comprises an output for a second right output signal V_{ortho,right} in response to the external magnetic field. In the illustrated example, second right bridge circuit 320-R is implemented as a Wheatstone bridge having four first magneto-resistors 322. Ideally (e.g., without stress), the reference magnetization of the magneto-resistors 322 of the left leg points in positive y-direction. Ideally, the reference magnetization of the magneto-resistors 322 of the right leg points in negative y-direction. Second right bridge circuit 320-R may optionally comprise an offset trim component to correct any inherent offsets in the sensor output, ensuring that the output is accurately centered around zero when no external magnetic field is present. In the illustrated example, second right bridge circuit 320-R is configured to measure a y-component of the external magnetic field and produces an output voltage V_{ortho,right}. The output voltage V_{ortho,right} may be a difference in voltage between middle nodes of the left and right legs of the second right bridge circuit 320-R. The skilled person having benefit from the present disclosure will appreciate that second bridge circuit 320 could as well be implemented as a half bridge.

Differential sensor circuit 400 further comprises a right sensor 330-R configured to measure the physical quantity indicative of a reference magnetization rotation θ of the first right magneto-resistors 312 and the second right magneto-resistors 322. The physical quantity measured by sensor 330-R may be mechanical stress, temperature, or any other factor that influences the orientation of the reference magnetization in the magneto-resistors.

Processing circuitry 340 of differential sensor circuit 400 may be configured to determine the compensated left output signal according to

$${B}_{x , left} \approx {B}_{sens , left} - {B}_{ortho , left} {σ}_{x y} {c}_{cr} ,$$

and the compensated right output signal according to

$${B}_{x , right} \approx {B}_{sens , right} - {B}_{ortho , right} {σ}_{x y} {c}_{cr} .$$

The compensated differential output signal may then be determined according to

$${B}_{diff} = {B}_{x , left} - {B}_{x , r ight} .$$

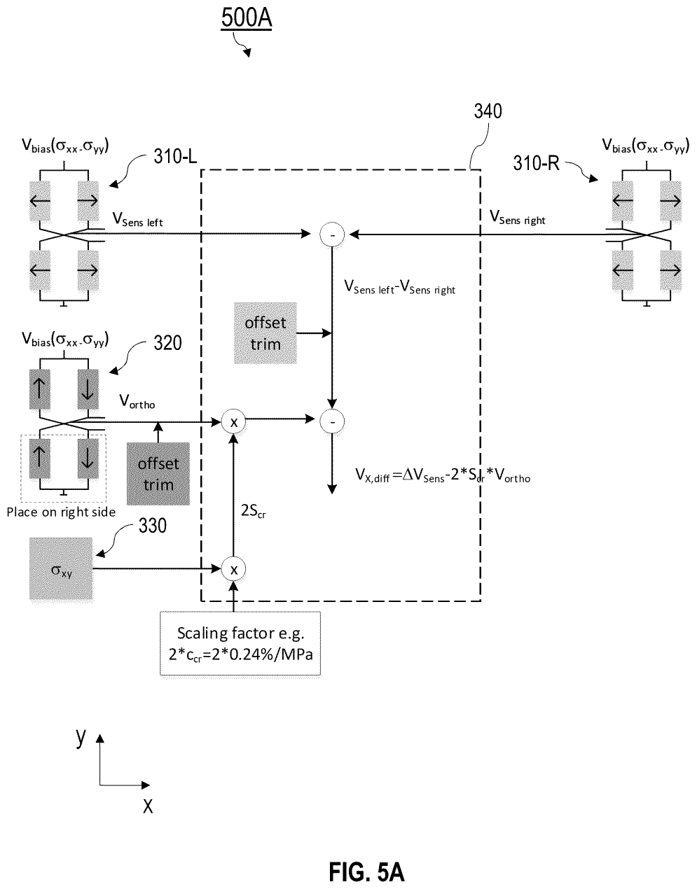

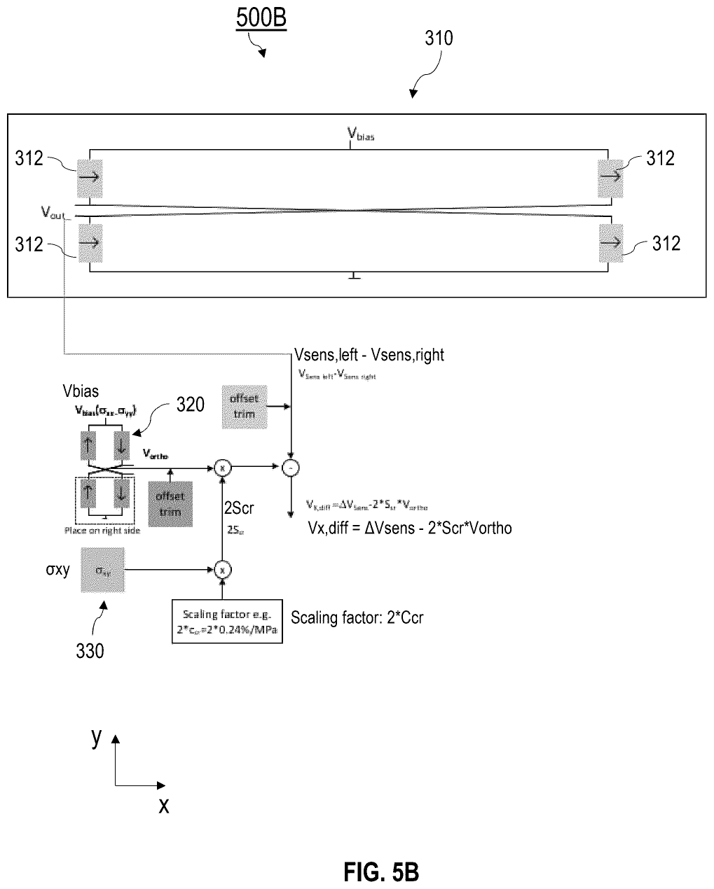

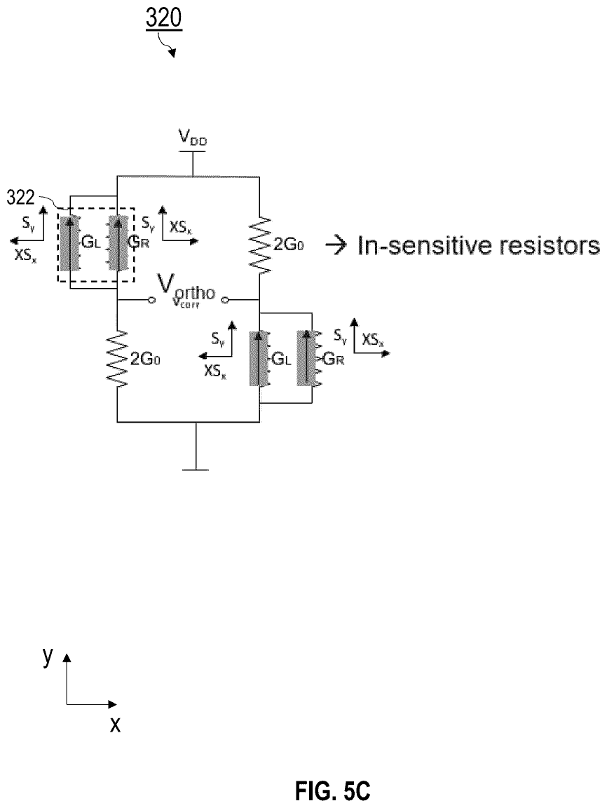

FIG. 5A shows a differential sensor circuit 500A according to another implementation of the present disclosure. Here, Bₓ may also be determined differentially.

Differential sensor circuit 500A comprises a first left bridge circuit 310-L. First left bridge circuit 310-L comprises a plurality of first magneto-resistors 312 having a first reference magnetization along a first directional axis (here: x-axis). First left bridge circuit 310-L also comprises an output for a first left output signal V_{sens,left} in response to an external magnetic field. In the illustrated example, first left bridge circuit 310-L is implemented as a Wheatstone bridge having four first magneto-resistors 312. Ideally (e.g., without stress), the reference magnetization of the magneto-resistors 312 of the left leg points in negative x-direction. Ideally, the reference magnetization of the magneto-resistors 312 of the right leg points in positive x-direction. First left bridge circuit 310-L may optionally comprise an offset trim component to correct any inherent offsets in the sensor output, ensuring that the output is accurately centered around zero when no external magnetic field is present. In the illustrated example, first left bridge circuit 310-L is configured to measure an x-component of an external magnetic field and produces an output voltage V_{sens,left}. The output voltage V_{sens,left} may be a difference in voltage between middle nodes of the left and right legs of the first left bridge circuit 310-L. The skilled person having benefit from the present disclosure will appreciate that first left bridge circuit 310-L could as well be implemented as a half bridge.

Differential sensor circuit 500A additionally comprises a first right bridge circuit 310-R placed in close proximity but separated by a small distance from first left bridge circuit 310-L. First right bridge circuit 310-R comprises a plurality of first magneto-resistors 312 having a first reference magnetization along a first directional axis (here: x-axis). First right bridge circuit 310-R also comprises an output for a first right output signal V_{sens,right in response to the external magnetic field. In the illustrated example, first right bridge circuit 310-R is implemented as a Wheatstone bridge having four first magneto-resistors 312. Ideally (e.g., without stress), the reference magnetization of the magneto-resistors 312 of the left leg points in negative x-direction. Ideally, the reference magnetization of the magneto-resistors 312 of the right leg points in positive x-direction. First right bridge circuit 310-R may optionally comprise an offset trim component to correct any inherent offsets in the sensor output, ensuring that the output is accurately centered around zero when no external magnetic field is present. In the illustrated example, first right bridge circuit 310-R is configured to measure an x-component of an external magnetic field and produces an output voltage V}_{sens,right}. The output voltage V_{sens,right may be a difference in voltage between middle nodes of the left and right legs of the first right bridge circuit 310-R. The skilled person having benefit from the present disclosure will appreciate that first right bridge circuit 310-R could as well be implemented as a half bridge.}

Differential sensor circuit 500A additionally comprises a second bridge circuit 320 (which may be associated with the first left bridge circuit 310-L and/or with the first right bridge circuit 310-R). Second bridge circuit 320 comprises a plurality of second magneto-resistors 322 having a second reference magnetization along a second directional axis (here: y-axis). Second bridge circuit 320 also comprises an output for a second output signal Vₒᵣₜₕₒ in response to the external magnetic field. In the illustrated example, second bridge circuit 320 is implemented as a Wheatstone bridge having four first magneto-resistors 322. Ideally (e.g., without stress), the reference magnetization of the magneto-resistors 322 of the left leg points in positive y-direction. Ideally, the reference magnetization of the magneto-resistors 322 of the right leg points in negative y-direction. Second bridge circuit 320 may optionally comprise an offset trim component to correct any inherent offsets in the sensor output, ensuring that the output is accurately centered around zero when no external magnetic field is present. In the illustrated example, second bridge circuit 320 is configured to measure a y-component of the external magnetic field and produces an output voltage Vₒᵣₜₕₒ. The output voltage Vₒᵣₜₕₒ may be a difference in voltage between middle nodes of the left and right legs of the second bridge circuit 320-L. The skilled person having benefit from the present disclosure will appreciate that second bridge circuit 320 could as well be implemented as a half bridge.

Differential sensor circuit 500A further comprises a sensor 330 configured to measure a physical quantity indicative of a reference magnetization rotation θ of the first magneto-resistors 312 and the second magneto-resistors 322. The physical quantity measured by sensor 330 may be mechanical stress, temperature, or any other factor that influences the orientation of the reference magnetization in the magneto-resistors 312, 322.

Processing circuitry 340 of differential sensor circuit 500A may be configured to determine a differential uncompensated output signal according to

$${B}_{sens , diff} = {B}_{sens , left} - {B}_{sens , right} ,$$

and the differential compensated output signal according to

$${B}_{x , diff} = {B}_{sens , diff} - 2 {B}_{ortho} {S}_{c r} .$$

FIG. 5B shows a differential sensor circuit 500B according to another implementation of the present disclosure. Here, Bₓ may also be determined differentially.

Compared to FIG. 5A, differential sensor circuit 500B comprises only one first bridge circuit 310. First bridge circuit 310 of FIG. 5A comprises an upper left magneto-resistor 312, a lower left magneto-resistor 312, an upper right magneto-resistor 312, and a lower right magneto-resistor 312. The left and right magneto-resistors are placed in close proximity but separated by a distance large enough for differential measurements. The reference magnetization of upper left magneto-resistor 312 and lower left magneto-resistor 312 points in positive x-direction. The reference magnetization of upper right magneto-resistor 312 and lower right magneto-resistor 312 also points in positive x-direction. Upper left magneto-resistor 312 and lower right magneto-resistor 312 are connected in series between supply potential and ground (first series connection). Upper right magneto-resistor 312 and lower left magneto-resistor 312 are connected in series between supply potential and ground (second series connection). The output voltage Vₒᵤₜ may be a voltage difference between the node between upper left magneto-resistor 312 and lower right magneto-resistor 312 and the node between upper right magneto-resistor 312 and lower left magneto-resistor 312, for example.

FIG. 5C shows an alternative setup for the second bridge circuit 320.

The second bridge circuit 320 of FIG. 5C comprises an upper left magneto-resistor 322 (G_{L}∥G_{R}), a lower left (insensitive) resistor 2G₀, an upper right (insensitive) resistor 2G₀, and a lower right magneto-resistor 322 (G_{L}∥G_{R}). The reference magnetization of upper left magneto-resistor 322 and lower left magneto-resistor 322 points in positive y-direction. Upper left magneto-resistor 322 and lower left (insensitive) resistor 2G₀ are connected in series between supply potential and ground (first series connection). Upper right (insensitive) resistor 2G₀, and lower right magneto-resistor 322 (G_{L}∥G_{R}) connected in series between supply potential and ground (second series connection). The output voltage Vₒᵣₜₕₒ may be a difference in voltage between middle nodes the first series connection and the second series connection of the alternative second bridge circuit 320.

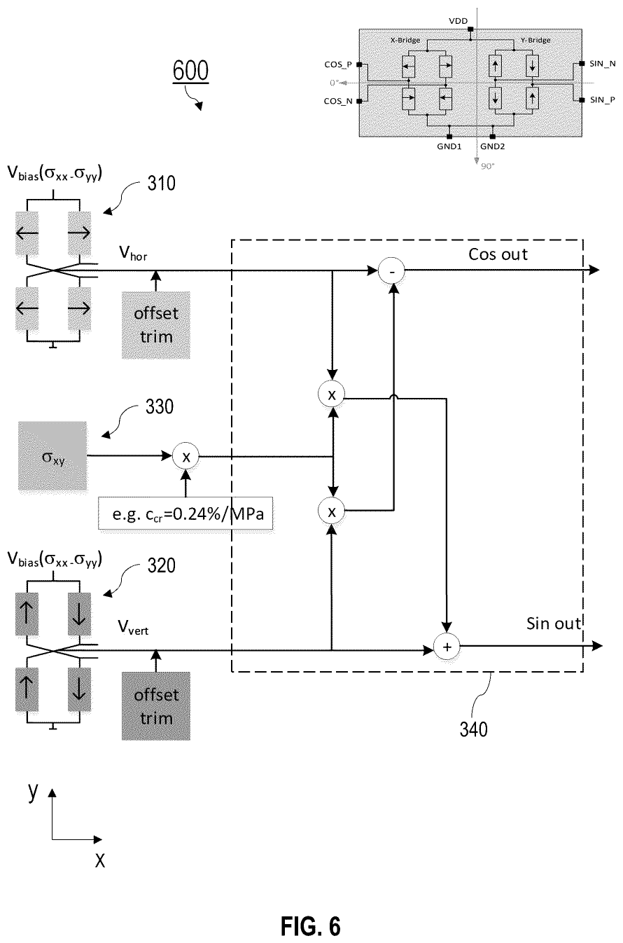

FIG. 6 shows an angle sensor circuit 600 according to an implementation of the present disclosure. An angle sensor typically measures the cosine (cos) and sine (sin) components of a magnetic field to determine the angle of the magnetic field vector relative to a reference axis. This method may be commonly used in angle sensors based on magnetic field sensing, such as those using Hall effect sensors, TMR (Tunnel Magneto-Resistance) sensors, or AMR (Anisotropic Magneto-Resistance) sensors.

Here, the first bridge circuit 310 may measure the cos-component of the angle (cos θ), the second bridge circuit 320 may measure the sin-component of the angle (sin θ). In the illustrated implementation, the processing circuitry 340 of angle sensor circuit 600 is configured to determine a first compensated output signal (cos out) based on a difference between the first output signal Vₕₒᵣ from the first bridge circuit 310 and the second output signal Vᵥₑᵣₜ from the second bridge circuit 310 which is scaled based on the measured physical quantity from sensor 330. That is, processing circuitry 340 may be configured to determine the first compensated output signal based on

$${B}_{x} \approx {B}_{h o r} - {B}_{vert} {S}_{cr} , or$$

$${B}_{x} \approx {B}_{h o r} - {B}_{vert} {σ}_{x y} {c}_{c r} .$$

A second compensated output signal (sin out) is determined based on a sum of the second output signal Vᵥₑᵣₜ and the first output signal Vₕₒᵣ scaled based on the measured physical quantity from sensor 330. That is, processing circuitry 340 may be configured to determine the second compensated output signal based on

$${B}_{y} \approx {B}_{vert} + {B}_{h o r} {S}_{cr} , or$$

$${B}_{y} \approx {B}_{vert} + {B}_{h o r} {σ}_{x y} {c}_{c r} .$$

Additionally or alternatively, a second order compensation of Bₓ may be done based on

$${B}_{x} \approx {B}_{h o r} ( 1 - \frac{{S}_{c r}^{2}}{2} ) - {B}_{vert} {S}_{c r} or$$

$${B}_{x} \approx {B}_{h o r} ( 1 - \frac{{σ}_{x y}^{2} {c}_{c r}^{2}}{2} ) - {B}_{vert} {σ}_{xy} {c}_{cr} .$$

A second order compensation of B_{y} may be done based on

$${B}_{x} \approx {B}_{vert} ( 1 - \frac{{S}_{c r}^{2}}{2} ) + {B}_{hor} {S}_{c r} , or$$

$${B}_{y} \approx {B}_{vert} ( 1 - \frac{{σ}_{x y}^{2} {c}_{c r}^{2}}{2} ) + {B}_{hor} {σ}_{xy} {c}_{cr} .$$

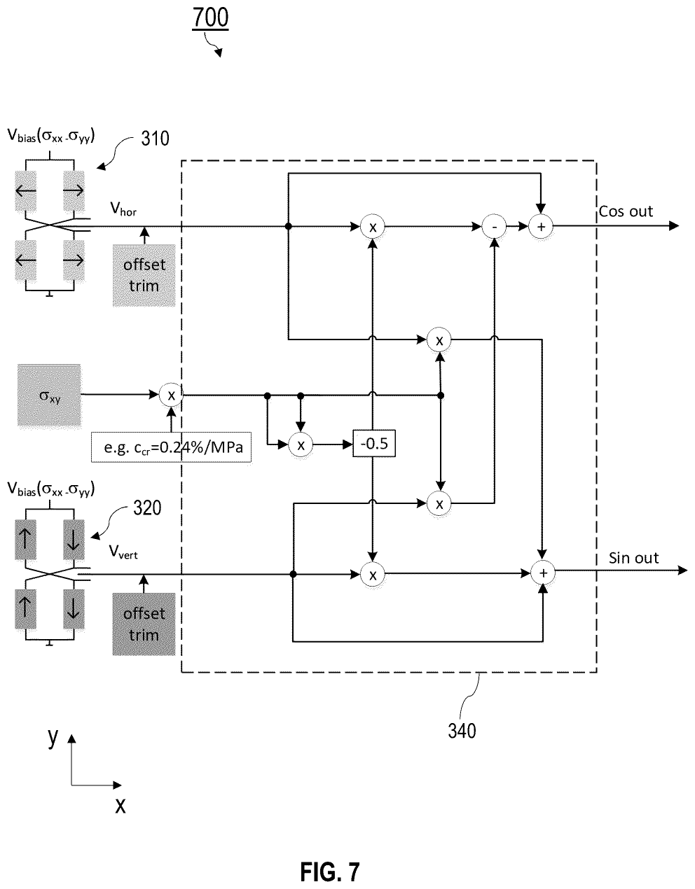

A corresponding angle sensor circuit 700 with second order compensation according to an implementation is shown in FIG. 7.

Thus, the processing circuitry 340 of angle sensor circuit 700 may be configured to determine the first compensated output signal based Bₓ on a difference between the first output signal Bₕₒᵣ scaled with a first scaling factor based on a squared cross sensitivity

$$( e . g . , ( 1 - \frac{{S}_{c r}^{2}}{2} ) or ( 1 - \frac{{σ}_{x y}^{2} {c}_{c r}^{2}}{2} ) )$$

and the second output signal Bᵥₑᵣₜ scaled with a second scaling factor based on the cross sensitivity. The processing circuitry 340 may be configured to determine the second compensated output signal By based on a sum of the second output signal Bᵥₑᵣₜ scaled with the first scaling factor

$$( e . g . , ( 1 - \frac{{S}_{c r}^{2}}{2} ) or ( 1 - \frac{{σ}_{x y}^{2} {c}_{c r}^{2}}{2} ) )$$

and the first output signal Bₕₒᵣ scaled with the second scaling factor.

The present disclosure proposes a sensor circuit and method for compensating mechanical stress in magnetoresistive (xMR) sensors. A problem addressed is that xMR sensors, which include AMR, GMR, TMR, and CMR sensors, may suffer from stress dependency issues. These issues may lead to changes in sensitivity and reference system rotation, causing stray field suppression problems in speed and current sensors and orthogonality errors in angle sensors.

The proposed solution involves a sensor circuit comprising first and second bridge circuits with magneto-resistors oriented along orthogonal axes to measure external magnetic fields. The circuit includes a sensor to measure physical quantities indicative of reference magnetization rotation caused by mechanical stress or other factors. Analog or digital processing circuitry determines a compensated output signal based on the first and second output signals and the measured physical quantity.

The bridge circuits may be configured as Wheatstone bridges, where the first bridge measures the x-component and the second measures the y-component of the magnetic field. The sensor may measure physical quantities like mechanical stress or temperature to indicate reference magnetization rotation. The analog or digital processing circuitry calculates compensated output signals to correct for errors caused by stress-induced magnetization rotation.

Advantages of this approach include improved accuracy and reliability of xMR sensors by compensating for stress effects. This may lead to enhanced measurement precision in applications requiring high accuracy, such as automotive sensors and industrial equipment.

Implementation variations involve the use of differential measurement techniques and compensation algorithms to reduce the influence of common-mode noise and other disturbances. Various circuit implementations and compensation methods include first and second-order compensations.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

### Aspects

The following provides an overview of some Aspects of the present disclosure:

Aspect 1: A sensor circuit, comprising: a first bridge circuit, comprising: a plurality of first magneto-resistors having a first reference magnetization along a first directional axis, and an output for a first output signal in response to an external magnetic field; a second bridge circuit, comprising: a plurality of second magneto-resistors having a second reference magnetization along a second directional axis, and an output for a second output signal in response to the external magnetic field; a sensor configured to measure a physical quantity indicative of a reference magnetization rotation of the first and second magneto-resistors; and processing circuitry configured to determine a compensated output signal based on the first output signal, the second output signal, and the physical quantity indicative of the reference magnetization rotation.

Aspect 2: The sensor circuit of Aspect 1, wherein the first reference magnetization and the second reference magnetization are orthogonal in absence of external perturbations acting on the sensor circuit.

Aspect 3: The sensor circuit of any of Aspects 1-2, wherein the first bridge circuit comprises a first Wheatstone bridge comprising four first magneto-resistors, and the second bridge circuit comprises a second Wheatstone bridge comprising four second magneto-resistors.

Aspect 4: The sensor circuit of any of Aspects 1-3, wherein the first output signal is a difference in voltage between middle nodes of the first bridge circuit, and the second output signal is a difference in voltage between middle nodes of the second bridge circuit.

Aspect 5: The sensor circuit of any of Aspects 1-4, wherein the sensor is configured to measure a mechanical stress acting on the sensor circuit as the physical quantity indicative of the reference magnetization rotation.

Aspect 6: The sensor circuit of any of Aspects 1-5, wherein the sensor is configured to measure a temperature acting on the sensor circuit as the physical quantity indicative of the reference magnetization rotation.

Aspect 7: The sensor circuit of any of Aspects 1-6, wherein the processing circuitry is configured to scale the measured physical quantity by a predetermined scaling factor.

Aspect 8: The sensor circuit of any of Aspects 1-7, wherein the processing circuitry is configured to determine the compensated output signal based on a difference between the first output signal and the second output signal scaled based on the measured physical quantity.

Aspect 9: The sensor circuit of any of Aspects 1-8, wherein the processing circuitry is configured to: determine a first compensated output signal based on a difference between the first output signal and the second output signal scaled based on the measured physical quantity, and determine a second compensated output signal based on a sum of the second output signal and the first output signal scaled based on the measured physical quantity.

Aspect 10: The sensor circuit of any of Aspects 1-9, wherein the processing circuitry is configured to: determine a first compensated output signal based on a difference between the first output signal scaled with a first scaling factor based on a squared cross sensitivity and the second output signal scaled with a second scaling factor based on the squared cross sensitivity, and determine a second compensated output signal based on a sum of the second output signal scaled with the first scaling factor and the first output signal scaled with the second scaling factor.

Aspect 11: The sensor circuit of Aspect 10, further comprising: a third bridge circuit, comprising: a plurality of third magneto-resistors having the first reference magnetization in the first direction, and an output for a third output signal in response to the external magnetic field, wherein the first and the third bridge circuit from a differential sensor; and wherein the processing circuitry is configured to determine the compensated output signal based on the first to third output signals and the physical quantity indicative of the squared cross sensitivity.

Aspect 12: The sensor circuit of Aspect 11, wherein the processing circuitry is configured to determine the compensated output signal based on a difference between the first and third output signals, and second output signal scaled based on the measured physical quantity.

Aspect 13: The sensor circuit of any of Aspects 1-12, wherein the magneto-resistors are tunnel magneto-resistors.

Aspect 14: The sensor circuit of any of Aspects 1-13, wherein the sensor circuit is an integrated circuit.

Aspect 15: A method for compensating mechanical stress of a magneto-resistive sensor, the method comprising: receiving, in response to an external magnetic field, a first output signal from one or more first magneto-resistors having a first reference magnetization in a first direction; receiving, in response to the external magnetic field, a second output signal from one or more second magneto-resistors having a second reference magnetization in a second direction; receiving an additional sensor signal indicative of a reference magnetization rotation of the first and second magneto-resistors; and determining a compensated output signal based on the first output signal, the second output signal, and the additional sensor signal.

Aspect 16: The method of Aspect 15, comprising: determining the compensated output signal based on a difference between the first output signal and the second output signal scaled based on the additional sensor signal.

Aspect 17: The method of any of Aspects 15-16, comprising: determining a first compensated output signal based on a difference between the first output signal and the second output signal scaled based on the additional sensor signal, and determining a second compensated output signal based on a sum of the second output signal and the first output signal scaled based on the additional sensor signal.

Aspect 18: The method of any of Aspects 15-17, comprising: determining a first compensated output signal based on a difference between the first output signal scaled with a first scaling factor based on a squared cross sensitivity and the second output signal scaled with a second scaling factor based on the squared cross sensitivity, and determining a second compensated output signal based on a sum of the second output signal scaled with the first scaling factor and the first output signal scaled with the second scaling factor.

Aspect 19: A computer program comprising a sequence of instructions, wherein the instructions, when executed by a processor, cause the processor to execute a method for compensating mechanical stress of a magneto-resistive sensor, the method comprising: receiving, in response to an external magnetic field, a first output signal from one or more first magneto-resistors having a first reference magnetization in a first direction; receiving, in response to the external magnetic field, a second output signal from one or more second magneto-resistors having a second reference magnetization in a second direction; receiving an additional sensor signal indicative of a reference magnetization rotation of the first and second magneto-resistors; and determining a compensated output signal based on the first output signal, the second output signal, and the additional sensor signal.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

1. A sensor circuit, comprising:
a first bridge circuit, comprising:
a plurality of first magneto-resistors having a first reference magnetization along a first directional axis, and
an output for a first output signal in response to an external magnetic field;
a second bridge circuit, comprising:
a plurality of second magneto-resistors having a second reference magnetization along a second directional axis, and
an output for a second output signal in response to the external magnetic field;
a sensor configured to measure a physical quantity indicative of a reference magnetization rotation of the first and second magneto-resistors; and
processing circuitry configured to determine a compensated output signal based on the first output signal, the second output signal, and the physical quantity indicative of the reference magnetization rotation.

2. The sensor circuit of claim 1, wherein the first reference magnetization and the second reference magnetization are orthogonal in absence of external perturbations acting on the sensor circuit.

3. The sensor circuit of claim 1, wherein the first bridge circuit comprises a first Wheatstone bridge comprising four first magneto-resistors, and the second bridge circuit comprises a second Wheatstone bridge comprising four second magneto-resistors.

4. The sensor circuit of claim 1, wherein the first output signal is a difference in voltage between middle nodes of the first bridge circuit, and the second output signal is a difference in voltage between middle nodes of the second bridge circuit.

5. The sensor circuit of claim 1, wherein the sensor is configured to measure a mechanical stress acting on the sensor circuit as the physical quantity indicative of the reference magnetization rotation.

6. The sensor circuit of claim 1, wherein the sensor is configured to measure a temperature acting on the sensor circuit as the physical quantity indicative of the reference magnetization rotation.

7. The sensor circuit of claim 1, wherein the processing circuitry is configured to scale the measured physical quantity by a predetermined scaling factor.

8. The sensor circuit of claim 1, wherein the processing circuitry is configured to determine the compensated output signal based on a difference between the first output signal and the second output signal scaled based on the measured physical quantity.

9. The sensor circuit of claim 1, wherein the processing circuitry is configured to:
determine a first compensated output signal based on a difference between the first output signal and the second output signal scaled based on the measured physical quantity, and
determine a second compensated output signal based on a sum of the second output signal and the first output signal scaled based on the measured physical quantity.

10. The sensor circuit of claim 1, wherein the processing circuitry is configured to;
determine a first compensated output signal based on a difference between the first output signal scaled with a first scaling factor based on a squared cross sensitivity and the second output signal scaled with a second scaling factor based on the squared cross sensitivity, and
determine a second compensated output signal based on a sum of the second output signal scaled with the first scaling factor and the first output signal scaled with the second scaling factor.

11. The sensor circuit of claim 10, further comprising:
a third bridge circuit, comprising:
a plurality of third magneto-resistors having the first reference magnetization in the first direction, and
an output for a third output signal in response to the external magnetic field,
wherein the first and the third bridge circuit from a differential sensor; and
wherein the processing circuitry is configured to determine the compensated output signal based on the first to third output signals and the physical quantity indicative of the squared cross sensitivity.

12. The sensor circuit of claim 11, wherein the processing circuitry is configured to determine the compensated output signal based on a difference between the first and third output signals, and second output signal scaled based on the measured physical quantity.

13. The sensor circuit of claim 1, wherein the magneto-resistors are tunnel magneto-resistors.

14. The sensor circuit of claim 1, wherein the sensor circuit is an integrated circuit.

15. A method for compensating mechanical stress of a magneto-resistive sensor, the method comprising:
receiving, in response to an external magnetic field, a first output signal from one or more first magneto-resistors having a first reference magnetization in a first direction;
receiving, in response to the external magnetic field, a second output signal from one or more second magneto-resistors having a second reference magnetization in a second direction;
receiving an additional sensor signal indicative of a reference magnetization rotation of the first and second magneto-resistors; and
determining a compensated output signal based on the first output signal, the second output signal, and the additional sensor signal.

16. The method of claim 15, comprising:
determining the compensated output signal based on a difference between the first output signal and the second output signal scaled based on the additional sensor signal.

17. The method of claim 15, comprising:
determining a first compensated output signal based on a difference between the first output signal and the second output signal scaled based on the additional sensor signal, and
determining a second compensated output signal based on a sum of the second output signal and the first output signal scaled based on the additional sensor signal.

18. The method of claim 15, comprising:
determining a first compensated output signal based on a difference between the first output signal scaled with a first scaling factor based on a squared cross sensitivity and the second output signal scaled with a second scaling factor based on the squared cross sensitivity, and
determining a second compensated output signal based on a sum of the second output signal scaled with the first scaling factor and the first output signal scaled with the second scaling factor.

19. A computer program comprising a sequence of instructions, wherein the instructions, when executed by a processor, cause the processor to execute a method for compensating mechanical stress of a magneto-resistive sensor, the method comprising:
receiving, in response to an external magnetic field, a first output signal from one or more first magneto-resistors having a first reference magnetization in a first direction;
receiving, in response to the external magnetic field, a second output signal from one or more second magneto-resistors having a second reference magnetization in a second direction;
receiving an additional sensor signal indicative of a reference magnetization rotation of the first and second magneto-resistors; and
determining a compensated output signal based on the first output signal, the second output signal, and the additional sensor signal.
